(19) United States
(12) Patent Application Publication
(10) Pub. No.: US 2016/0011445 A1
(43) Pub. Date: Jan. 14, 2016

(54) DISPLAY PANEL

(71) Applicant: InnoLux Corporation, Miao-Li County (TW)

(72) Inventors: Ren-Lung CHEN, Miao-Li County (TW); Hang-Lang LEE, Miao-Li County (TW); Ju-Sung LU, Miao-Li County (TW); Jian-Cheng CHEN, Miao-Li County (TW)

(21) Appl. No.: 14/735,943

(22) Filed: Jun. 10, 2015

(30) Foreign Application Priority Data
Jul. 9, 2014 (TW) 103123658

(51) Int. Cl. G02F 1/1339; G02F 1/1337; G02F 1/1343; G02F 1/1335

(52) U.S. Cl. CPC G02F 1/1339; G02F 1/133512; G02F 1/1337; G02F 1/13394; G02F 1/13439

(57) ABSTRACT

A display panel comprises a first substrate, a second substrate disposed opposite the first substrate, a liquid crystal layer, a sealant, at least a spacer, a first alignment layer and a second alignment layer. The liquid crystal layer is disposed between the first substrate and the second substrate. The sealant seals the periphery of the first substrate and second substrate. The spacer is disposed within the sealant. The first alignment layer is disposed on the first substrate. The second alignment layer is disposed on the second substrate. The first alignment layer or the second alignment layer at least covers partial surface of the spacer.

### CROSS REFERENCE TO RELATED APPLICATIONS

This Non-provisional application claims priority under 35 U.S.C. §119(a) on Patent Application No(s). 103123658 filed in Taiwan, Republic of China on Jul. 9, 2014, the entire contents of which are hereby incorporated by reference.

### BACKGROUND OF THE INVENTION

1. Field of Invention

The invention relates to a display panel and, in particular, to a display panel that can reduce the Mura diffusing from the border region to the display region to affect the quality of the image.

2. Related Art

With the progress of technologies, flat display devices have been widely applied to various kinds of fields. Especially, liquid crystal display (LCD) devices, having advantages such as compact structure, low power consumption, less weight and less radiation, gradually take the place of cathode ray tube (CRT) display devices, and are widely applied to various electronic products, such as mobile phones, portable multimedia devices, notebooks, LCD TVs and LCD screens.

A conventional liquid crystal display (LCD) apparatus mainly includes an LCD panel and a backlight module. The LCD panel mainly includes a thin film transistor (TFT) substrate, a color filter (CF) substrate and a liquid crystal layer disposed between the two substrates. The conventional manufacturing process of the LCD panel includes the steps of: disposing a sealant on the edges of a TFT substrate for example; disposing the liquid crystal within the sealant; making the TFT substrate and a CF substrate adhere to each other in a vacuum environment; and curing the sealant to obtain an LCD panel.

When the liquid crystal is injected, the liquid crystal will flow to the edges of the panel. However, because the sealant has not been cured, the chemical reaction generated between the liquid crystal molecules and the sealant will cause the dissolution of the sealant. In the worse case, the liquid crystal will be polluted, and therefore the Mura will be generated in the border region of the display device.

Therefore, it is an important subject to provide a display panel that can reduce the Mura occurring in the border region.

### SUMMARY OF THE INVENTION

In view of the foregoing subject, an objective of the invention is to provide a display panel that can reduce the Mura occurring in the border region.

To achieve the above objective, a display panel according to the invention comprises a first substrate, a second substrate disposed opposite the first substrate, a liquid crystal layer, a sealant, at least a spacer, a first alignment layer and a second alignment layer. The liquid crystal layer is disposed between the first substrate and the second substrate. The sealant surrounds the liquid crystal layer. The spacer is disposed within the sealant. The first alignment layer is disposed on the first substrate. The second alignment layer is disposed on the second substrate. The first alignment layer or the second alignment layer at least covers partial surface of the spacer.

In one embodiment, the first alignment layer covers the entire surface of the spacer and is extended to an edge of the first substrate.

In one embodiment, the second alignment layer covers the entire surface of the spacer and is extended to an edge of the second substrate.

In one embodiment, the display panel further comprises a first transparent conductive layer. The first transparent conductive layer is disposed on the first substrate and extended to an edge of the first substrate. The spacer is disposed on the first transparent conductive layer.

In one embodiment, the display panel further comprises a protective layer. The protective layer is disposed on the second substrate and comprises at least a recess corresponding to the sealant.

In one embodiment, the recess is disposed within the sealant or disposed partially within the sealant and partially outside the sealant.

In one embodiment, the display panel further comprises a second transparent conductive layer disposed on the protective layer. The second alignment layer is disposed on the second transparent conductive layer and extended to cover the recess.

In one embodiment, the second transparent conductive layer is disposed on the protective layer that is disposed within the sealant, and the spacer is disposed on the second transparent conductive layer.

In one embodiment, the spacer is disposed corresponding to the protective layer.

In one embodiment, the display panel further comprises a light blocking layer disposed on the first substrate and comprising at least a recess corresponding to the sealant. The recess is disposed within the sealant or disposed partially within the sealant and partially outside the sealant.

As mentioned above, in the display panel of the invention, the spacer is disposed within the sealant, the first alignment layer and the second alignment layer are extended to within the sealant, and the first alignment layer or the second alignment layer at least covers the partial surface of the spacer. In comparison with the conventional art, the spacer, first alignment layer and second alignment layer disposed in this invention can lower down the flow rate of the liquid crystal flowing to the sealant. Thereby, the total time of the chemical reaction between the liquid crystal molecules and the sealant can be reduced. Therefore, the Mura occurring in the border region and diffusing to the display region to affect the quality of the image of the display panel can be reduced.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic sectional diagram of a part of a display panel of an embodiment of the invention;

FIG. 1B is a schematic sectional diagram of a part of a display panel of another embodiment of the invention;

FIGS. 2A to 2G are schematic diagrams showing the shapes of the spacer in a top view of the first substrate in FIG. 1A;

FIG. 3A is a schematic diagram showing the contact angles between the liquid crystal molecule and the alignment layer and between the liquid crystal molecule and the transparent conductive layer;

FIG. 3B is a schematic diagram showing the variation of the contact angles with the time and combinations of different liquid crystal molecules and different alignment layers or transparent conductive layer;

FIGS. 4A and 4B are schematic diagrams of the display panels of different embodiments of the invention; and

FIG. 5 is a schematic diagram of a display device of an embodiment of the invention.

### DETAILED DESCRIPTION OF THE INVENTION

The present invention will be apparent from the following detailed description, which proceeds with reference to the accompanying drawings, wherein the same references relate to the same elements.

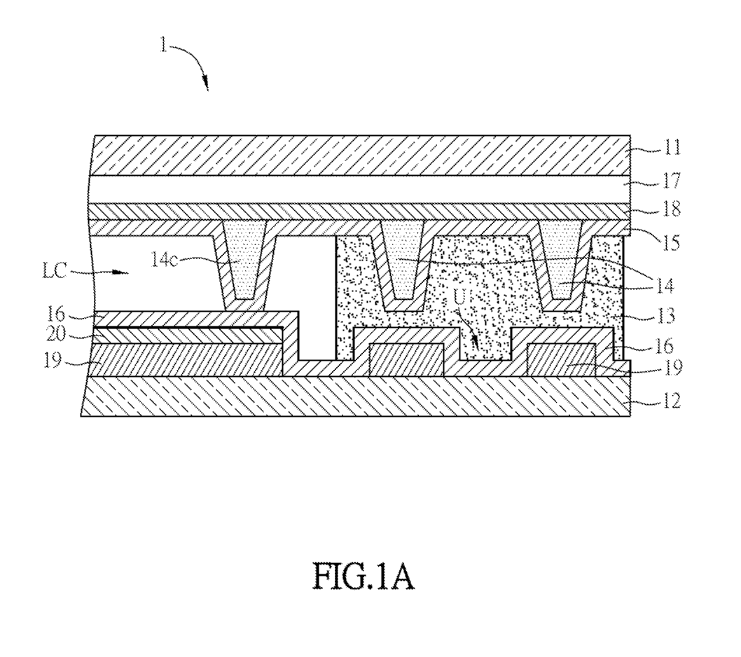

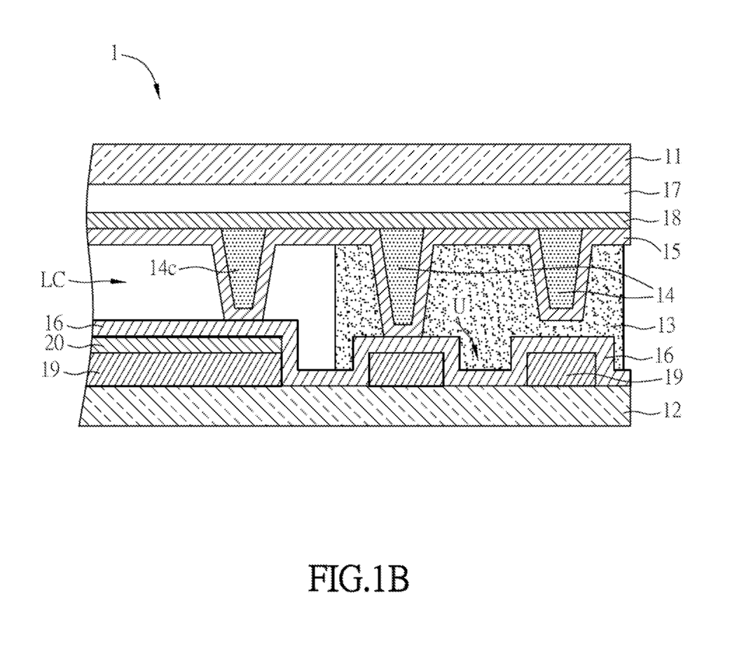

FIG. 1A is a schematic sectional diagram of a part of a display panel of an embodiment of the invention.

As shown in FIG. 1A, the display panel 1 includes a first substrate 11, a second substrate 12, a sealant 13, at least a spacer 14, a first alignment layer 15 and a second alignment layer 16. Besides, the display panel 1 of this embodiment further includes a light blocking layer 17, a first transparent conductive layer 18, a protective layer 19 and a second transparent conductive layer 20.

The first substrate 11 and the second substrate 12 are disposed oppositely. The first substrate 11 or the second substrate 12 can be made by transparent material, such as glass, quartz or the like, plastic material, rubber, fiberglass or other polymer materials. Otherwise, the first substrate 11 or the second substrate 12 can be made by opaque material and can be a metal-fiberglass composite board, metal-ceramic composite board, printed circuit board or others. In this embodiment, the substrate 11 and the second substrate 12 are both made by transparent glass for example.

The sealant 13 is disposed between the first substrate 11 and second substrate 12 and surrounds the liquid crystal layer (comprising liquid crystal molecules). Herein, the sealant 13 is disposed on and seals the periphery of the first substrate 11 and second substrate 12. The sealant 13 can be a heat-curing adhesive, photo-curing adhesive or their combination. Herein for example, the sealant 13 is a photo-curing adhesive (such as UV adhesive) and is formed on the periphery of the first substrate 11 and second substrate 12 in a coating manner under the atmosphere. The sealant 13, the first substrate 11 and the second substrate 12 can form an accommodating space (not shown) for the liquid crystal so that the liquid crystal molecules LC can be disposed in the accommodating space. That is, the accommodating space is the space between the first substrate and the second substrate and surrounded by the sealant 13, and the liquid crystal molecules, the wires and the thin film transistors area are disposed within the accommodating space. Herein for example, the liquid crystal molecules LC are formed by the ODF (one drop filling) process and disposed within the region formed by the sealant 13.

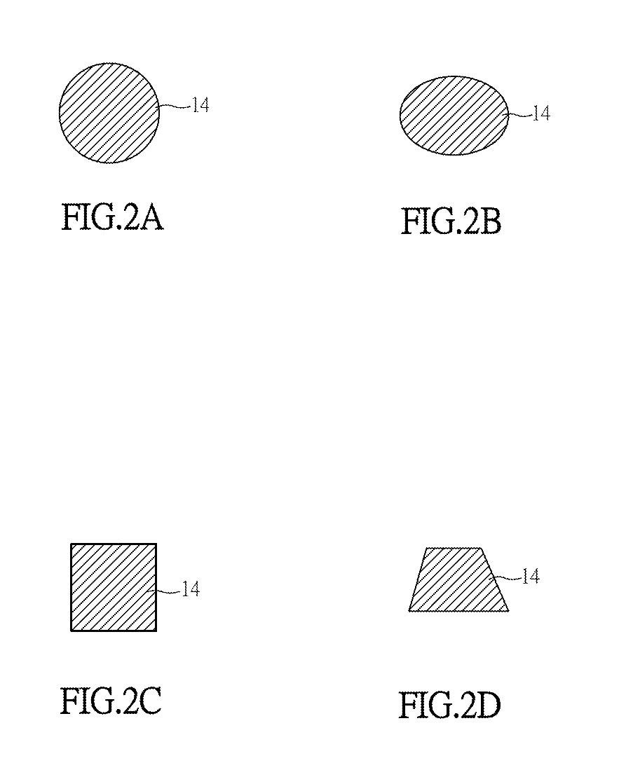

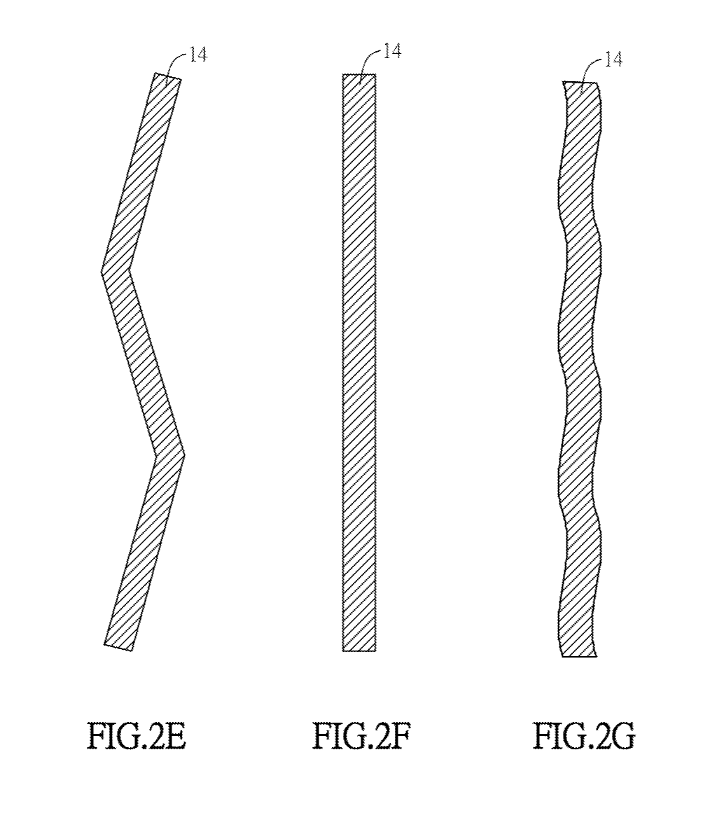

The spacer 14 is disposed between the first substrate 11 and the second substrate 12 and within the sealant 13. Herein for example, two spacers 14 are disposed on the first substrate 11 and within the sealant 13. The material of the spacer 14 can include resin, silicate, fiberglass or other photosensitive photoresist materials. As shown in FIGS. 2A to 2D, in a top view of the first substrate 11, the spacer 14 can have a circular shape (FIG. 2A), an elliptic shape (FIG. 2B), a polygonal shape (such as a square in FIG. 2C, a rectangle, a trapezoid in FIG. 2D, or a right pentagon), an irregular shape, or their any combination. However, this invention is not limited thereto. In other embodiments, in a top view, the spacer 14 within the sealant 13 can have a bending shape (FIG. 2E), a strip shape (FIG. 2F) or a wavy shape.

As shown in FIG. 1A, other spacers 14c (only one spacer 14c is shown in FIG. 1A) can be disposed within the accommodating space that is formed for storing the liquid crystal molecules LC and by the sealant 13, the first substrate 11 and the second substrate 12. The spacer 14c can keep the gap between the first substrate 11 and the second substrate 12, and therefore the liquid crystal molecules LC can be disposed within the space to make the display panel 1 become an LCD panel. Herein for example, the spacer 14 has the same height as the spacer 14c. However, in the embodiment of FIG. 1B, the spacer 14 and the spacer 14c can have different heights, and besides, the heights of the two spacers 14 within the sealant 13 may be different.

The light blocking layer 17 is disposed on the first substrate 11 and corresponding to the sealant 13. In this embodiment, in a top view of the first substrate 11, the light blocking layer 17 at least covers the sealant 13 and the spacer 14. The light blocking layer 17 is a black matrix and made by opaque material, such as metal (e.g. chromium, chromium oxide or Cr—O—N compound) or resin. Since the light blocking layer 17 is opaque, an opaque region can be formed on the first substrate 11 to define a transparent region. The display panel 1 can further include a color filter layer (not shown) disposed on the first substrate 11 or the light blocking layer 17. The color filter layer can include a red filter portion, a green filter portion and a blue filter portion. The color filter layer can be made by transparent material, such as pigment or dye. Moreover, the light blocking layer 17 and the color filter layer of this embodiment both can be disposed on the first substrate 11. In another embodiment, the light blocking layer 17 and/or the color filter layer can be disposed on the second substrate 12 so that the second substrate 12 can become a BOA (Black Matrix on array) substrate or a COA (color filter on array) substrate. To be noted, the above structures are just for the illustrative purpose but not for limiting the scope of the invention.

The first transparent conductive layer 18 is disposed on the side of the first substrate 11 facing the second substrate 12 and between the light blocking layer 17 and the first alignment layer 15. Herein, the first transparent conductive layer 18 is extended to the edge of the first substrate 11. The first transparent conductive layer 18 is a transparent conductive layer with the material of ITO or IZO for example, and herein ITO is taken as an example. The first transparent conductive layer 18 can be a common electrode. The display panel 1 of this embodiment is an LCD panel of a vertical switch type. However, in other embodiments, if the display panel 1 is an IPS (in-plane switch) LCD panel, the first transparent conductive layer 18 will be removed from the first substrate 11.

The first alignment layer 15 is disposed on the first substrate 11 and extended to the range of the sealant 13. The first alignment layer 15 or the second alignment layer 16 at least covers a partial surface of the spacer 14. In this embodiment, the spacer 14 is disposed on the first transparent conductive layer 18. The first alignment layer 15 is extended from the accommodating space for the liquid crystal molecules LC to the inside of the sealant 13 and covers the entire surface of the spacer 14. Besides, the first alignment layer 15 is extended to the edge of the first substrate 11 for example.

The protective layer 19 is disposed on the second substrate 12. The material of the protective layer 19 is, for example but not limited to, SiNx or SiOx. Moreover, the protective layer 19 includes at least a recess U corresponding to the sealant 13 (or the light blocking layer 17). The recess U can be disposed within the sealant 13 or disposed partially within the sealant 13 and partially outside the sealant 13. Herein for example, there are two recesses U corresponding to the sealant 13, one of the recesses U is disposed within the sealant 13, and the other is disposed partially within the sealant 13 and partially outside the sealant 13. Furthermore, the spacer 14 of this embodiment is disposed corresponding to the protective layer 19 that is within the sealant 13. However, in other embodiments, the spacer 14 may be disposed corresponding to the recess U. The recess U can elongate the flowing path of the liquid crystal molecules LC to delay the time that the liquid crystal molecules LC reach the sealant 13, and also can increase the contact area between the sealant 13 and the second substrate 12 so as to enhance the adhesion of the sealant 13. In another embodiment, the recess U can be disposed on the first substrate 11 and can be formed by the light blocking layer 17, the first transparent conductive layer 18 or the color filter layer (not shown).

The second transparent conductive layer 20 is disposed on the protective layer 19. The second transparent conductive layer 20 of this embodiment is just disposed in the accommodating space for the liquid crystal molecules LC but not disposed within the sealant 13. The second alignment layer 16 is disposed on the second transparent conductive layer 20 and extended from the accommodating space for the liquid crystal molecules LC to cover the recesses U and further extended to the edge of the second substrate 12. The second transparent conductive layer 20 can be a pixel electrode and disposed between the protective layer 19 and the second alignment layer 16. To be noted, the recess U of this embodiment can be formed by etching the portion of the second transparent conductive layer 20 within the sealant and etching the partial portion of the protective layer 19. In other embodiments, the recess U may be formed by only removing the second transparent conductive layer 20 or by removing the second transparent conductive layer 20 and the partial protective layer 19. In practice, there are other film layers, such as the first metal layer (M1), protective layer, second metal layer (M2), insulating layer or others, disposed between the protective layer 19 and the second substrate 12. In addition to removing the second transparent conductive layer 20 and protective layer 19 to form the recess U, the recess U also can be formed by removing the second transparent conductive layer 20, the protective layer 19 and the film layers between the second transparent conductive layer 20 and the protective layer 19. Moreover, the first alignment layer 15 covering the spacer 14 doesn't contact the second alignment layer 16. However, in another embodiment, the first alignment layer 15 covering the spacer 14 may contact the second alignment layer 16.

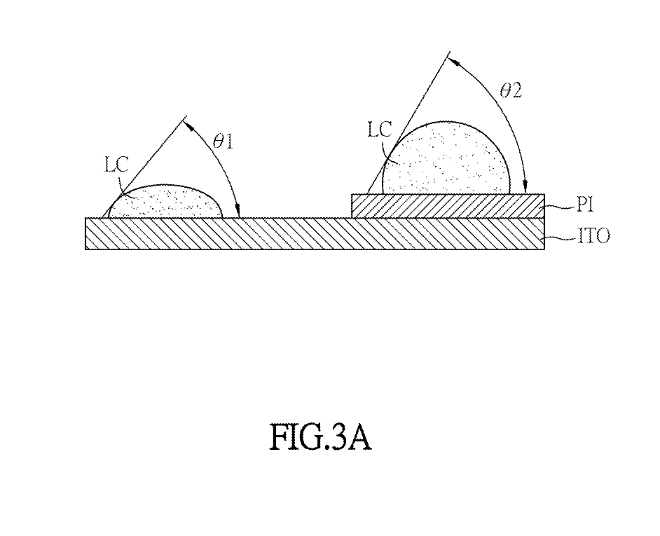

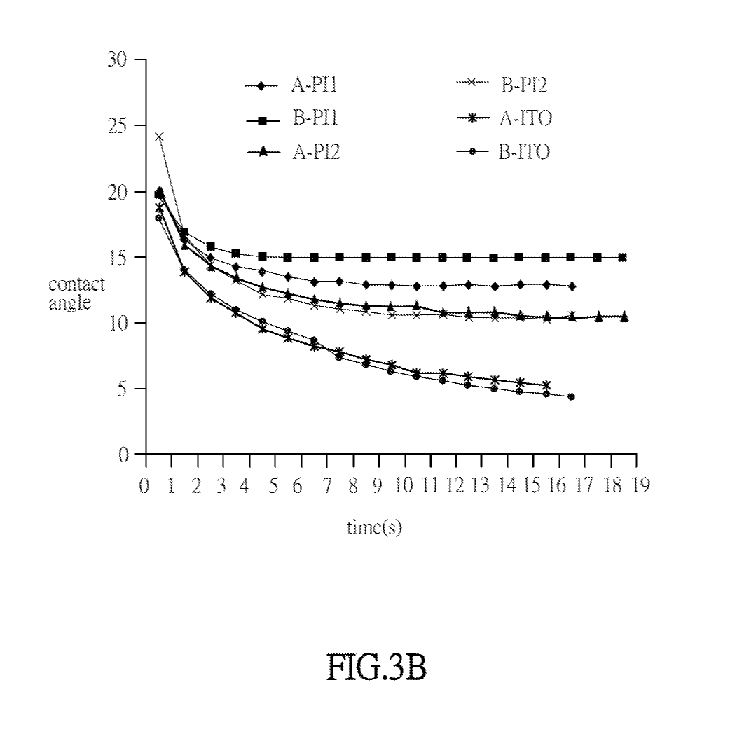

FIG. 3A is a schematic diagram showing the contact angles between the liquid crystal molecule and the alignment layer and between the liquid crystal molecule and the transparent conductive layer, and FIG. 3B is a schematic diagram showing the variation of the contact angles with the time and combinations of different liquid crystal molecules A and B and different alignment layers PI1 and PI2 or transparent conductive layer ITO.

As shown in FIG. 3A, the contact angle θ1 between the liquid crystal molecule LC and the transparent conductive layer ITO is less than the contact angle θ2 between the liquid crystal molecule LC and the alignment layer PI. Because the flow rate of the liquid crystal molecule LC is lower when the contact angle is larger, the flow rate of the liquid crystal molecule LC is lower on the alignment layer PI but higher on the transparent conductive layer ITO. So, if the alignment layer PI is used to slow down the flow rate of the liquid crystal molecule LC, the time that the liquid crystal molecules LC reach the sealant 13 and the generated chemical reaction can be delayed. That is, the total time of the chemical reaction between the liquid crystal molecules LC and the sealant 13 is reduced. Therefore, the probability of the liquid crystal molecules LC polluted due to the dissolution of the sealant 13 can be reduced.

As shown in FIG. 3B, from the variation curve of the contact angle between the liquid crystal molecules A and B and the alignment layer PI1 and PI2 and between the liquid crystal molecules A and B and the transparent conductive layer ITO, it can be seen that the contact angle between the liquid crystal molecules A and B and the alignment layer PI1 and PI2 is greater than that between the liquid crystal molecules A and B and the transparent conductive layer ITO at the same time. It demonstrates that the liquid crystal molecules have a lower flow rate on the alignment layer but a higher flow rate on the transparent conductive layer.

Since the flow rate of the liquid crystal molecules is lower on the alignment layer, in this embodiment as shown in FIG. 1A, the spacers 14 disposed within the sealant and the first alignment layer 15 and the second alignment layer 16 extended to within the sealant and to the edges of the first substrate 11 and the second substrate 12 can lower down the flow rate of the liquid crystal molecules LC flowing to the sealant 13. Therefore, the time that the liquid crystal molecules LC reach the sealant 13 and the generated chemical reaction can be delayed. That is, the total time of the chemical reaction between the liquid crystal molecules LC and the sealant 13 is reduced. Therefore, the probability of the liquid crystal molecules LC polluted due to the dissolution of the sealant 13 can be reduced, and the Mura occurring in the border region and diffusing to the display region to affect the quality of the image of the display panel 1 can be thus reduced. Besides, in this embodiment, the recess U is disposed on the protective layer 19 to elongate the flowing path of the liquid crystal molecules LC so as to reduce the probability and degree of the liquid crystal molecules LC dissolving the sealant 13. Therefore, the Mura can be further reduced. Besides, the recess U also can increase the contact area between the two substrates to enhance the adhesion therebetween.

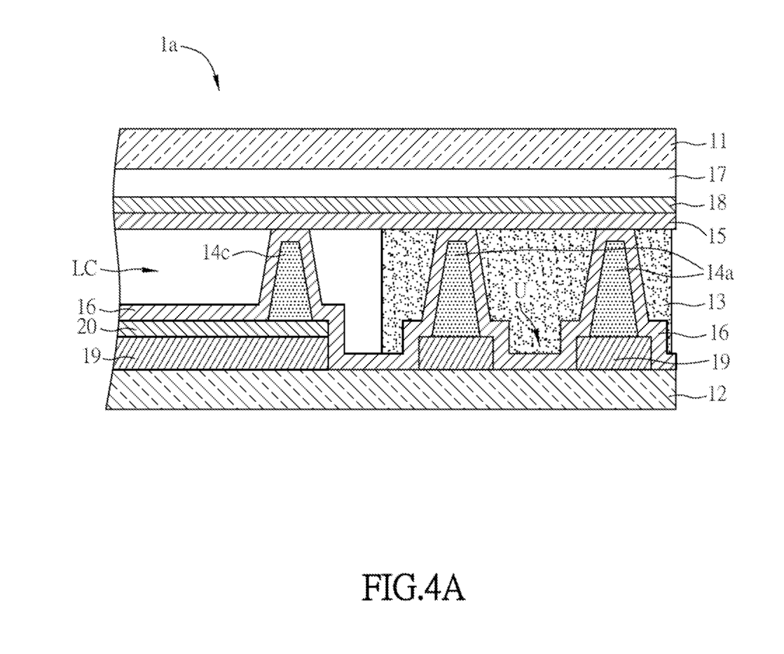

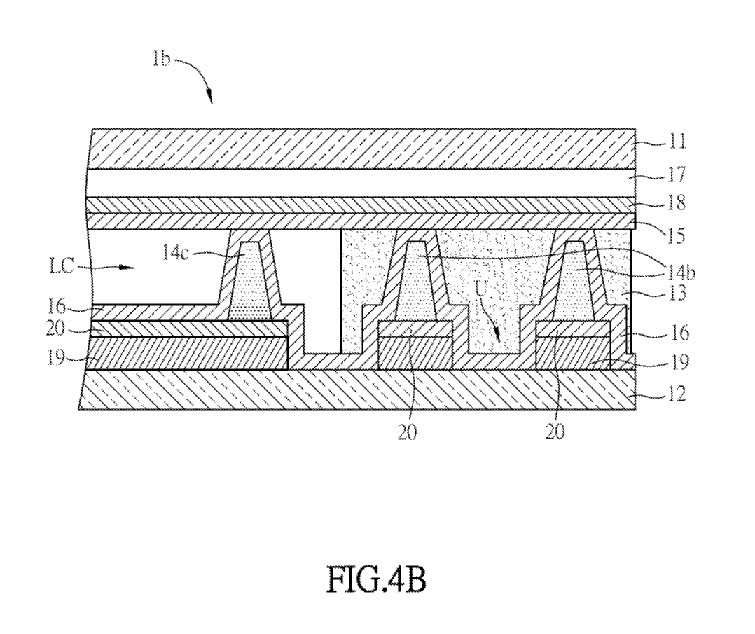

FIGS. 4A and 4B are schematic diagrams of the display panels 1a, 1b of different embodiments of the invention.

As shown in FIG. 4A, the main difference from the display panel 1 of FIG. 1A is that the spacer 14a of this embodiment is disposed on the second substrate 12 and the protective layer 19. Moreover, the second alignment layer 16 of this embodiment is extended from the accommodating space for the liquid crystal molecules LC to within the sealant 13 and further to the edge of the second substrate 12 and covers the entire surface of the spacer 14a. Besides, the spacer 14a and the spacer 14c in the accommodating space for the liquid crystal molecules LC have different heights, so that the second alignment layer 16 covering the spacers 14a and 14c can contact the first alignment layer 15. Other technical features of the display panel 1a can be comprehended by referring to the display panel 1 and therefore are not illustrated here for conciseness.

As shown in FIG. 4B, the main difference from the display panel 1a of FIG. 4A is that a second transparent conductive layer 20 is disposed on the protective layer 19 that is disposed within the sealant 13, and the spacers 14b are disposed on the second transparent conductive layer 20. Moreover, the height of the spacer 14b and the height of the spacer 14c in the accommodating space are substantially equal to each other. Since other technical features of the display panel 1b can be comprehended by referring to the display panel 1a, the related descriptions are omitted here for conciseness. In other embodiments, the recess U may be disposed on the first substrate (not shown).

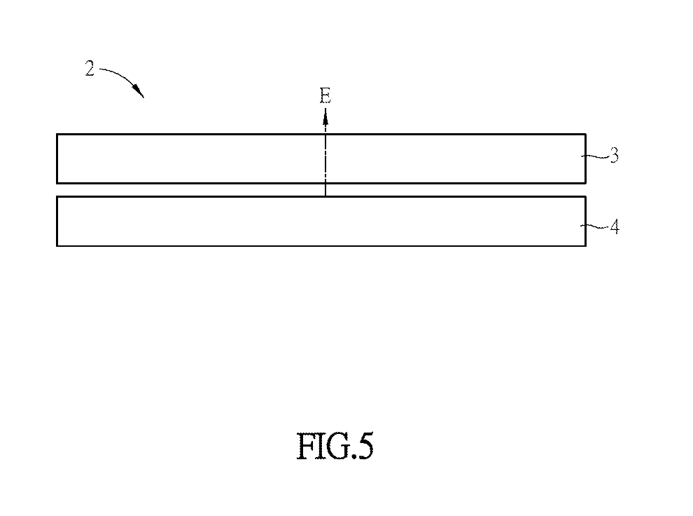

FIG. 5 is a schematic diagram of a display device 2 of an embodiment of the invention.

As shown in FIG. 5, the display device 2 includes a display panel 3 and a backlight module 4 disposed opposite the display panel 3. The display panel 3 can have the features of the above-mentioned display panel 1, 1a or 1b or their variations, and the related descriptions are thus omitted here for conciseness. When the light emitted by the backlight module 4 passes through the display panel 3, the pixels of the display panel 3 can display colors to form images.

Summarily, in the display panel of the invention, the spacer is disposed within the sealant, the first alignment layer and the second alignment layer are extended to within the sealant, and the first alignment layer or the second alignment layer at least covers the partial surface of the spacer. In comparison with the conventional art, the spacer, first alignment layer and second alignment layer disposed in this invention can lower down the flow rate of the liquid crystal flowing to the sealant. Thereby, the time that the liquid crystal molecules LC reach the sealant 13 and the generated chemical reaction can be delayed, and the probability of the liquid crystal molecules LC polluted due to the sealant 13 can be reduced. Therefore, the Mura occurring in the border region and diffusing to the display region to affect the quality of the image of the display panel can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel, comprising:
a first substrate;
a second substrate disposed opposite the first substrate;
a liquid crystal layer disposed between the first substrate and the second substrate;
a sealant disposed between the first substrate and the second substrate and surrounding the liquid crystal layer;
at least a spacer disposed between the first substrate and the second substrate and within the sealant;
a first alignment layer disposed on the first substrate; and
a second alignment layer disposed on the second substrate, wherein the first alignment layer or the second alignment layer at least covers partial surface of the spacer.

2. The display panel as recited in claim 1, wherein the first alignment layer covers the entire surface of the spacer and is extended to an edge of the first substrate.

3. The display panel as recited in claim 1, wherein the second alignment layer covers the entire surface of the spacer and is extended to an edge of the second substrate.

4. The display panel as recited in claim 1, further comprising:
a first transparent conductive layer disposed on the first substrate and extended to an edge of the first substrate, wherein the spacer is disposed on the first transparent conductive layer.

5. The display panel as recited in claim 1, further comprising:
a protective layer disposed on the second substrate and comprising at least a recess corresponding to the sealant.

6. The display panel as recited in claim 5, wherein the recess is disposed within the sealant or disposed partially within the sealant and partially outside the sealant.

7. The display panel as recited in claim 5, further comprising:
a second transparent conductive layer disposed on the protective layer, wherein the second alignment layer is disposed on the second transparent conductive layer and extended to cover the recess.

8. The display panel as recited in claim 7, wherein the second transparent conductive layer is disposed on the protective layer that is disposed within the sealant, and the spacer is disposed on the second transparent conductive layer.

9. The display panel as recited in claim 5, wherein the spacer is disposed corresponding to the protective layer.

10. The display panel as recited in claim 1, further comprising:
a light blocking layer disposed on the first substrate and comprising at least a recess corresponding to the sealant, wherein the recess is disposed within the sealant or disposed partially within the sealant and partially outside the sealant.
